(19) United States
(12) Patent Application Publication
(10) Pub. No.: US 2012/0168555 A1
(43) Pub. Date: Jul. 5, 2012

(54) AUTONOMOUS STRATOSPHERIC LIGHTER-THAN-AIR AIRCRAFT AND METHOD FOR PROVIDING RADIO AND OPTICAL COMMUNICATION, TELEVISION BROADCASTING AND MONITORING

(76) Inventors: Andrei Yurievich Shcherbakov, Moscow (RU); Malakhov Sergei Valentinovich, Zhukovsky (RU)

(21) Appl. No.: 13/261,154

(22) PCT Filed: Jul. 29, 2010
(86) PCT No.: PCT/EA2010/000006

§ 371 Date: Mar. 16, 2012

(30) Foreign Application Priority Data
Jul. 29, 2009 (EA) 200900908

(51) Int. Cl. B64B 1/00; B64F 5/00; B64C 37/02; B64D 47/02; H04B 7/185

(52) U.S. Cl. 244/2; 244/30

(57) ABSTRACT

The invention relates to an autonomous stratospheric aircraft which is lighter than air, and to a method for providing radio and optical communication, television broadcasting and monitoring with the aid of communication equipment arranged on the aircraft. The present invention can be used for producing lighter-than-air aircraft as well as global and regional communication and television broadcasting and multi-aspect monitoring systems and networks.

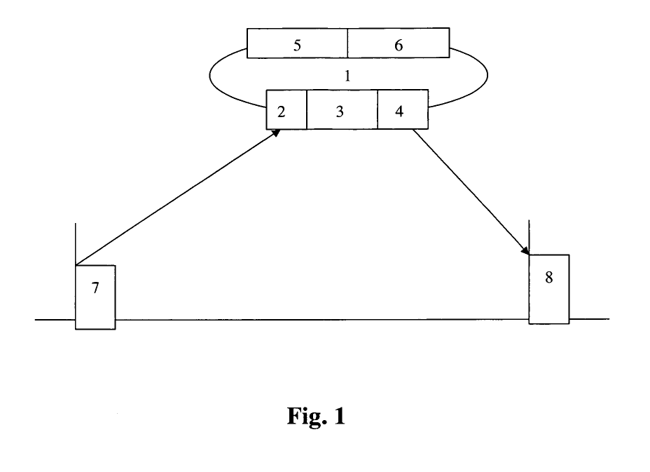

### CROSS-REFERENCE TO RELATED APPLICATIONS

This application is a U.S. national stage application of a PCT application PCT/EA2010/000006 filed on 29 Jul. 2010, published as WO/2011/012138, whose disclosure is incorporated herein in its entirety by reference, which PCT application claims priority of a EAPO application EA200900908 filed on 29 Jul. 2009.

### FIELD OF THE INVENTION

The invention basically relates to aeronautics and telecommunication, particularly to autonomous stratospheric aircraft being lighter than air, and to a method for providing radio and optical communication, television broadcasting, and monitoring with the aid of an apparatus arranged on the aforesaid aircraft.

The present invention can be utilized for creation of stratospheric lighter-than-air aircraft as well as global and regional communication and television broadcasting and multi-aspect monitoring systems and networks.

Nowadays, modern telecommunication systems and networks are required to cover vast territories. For satisfying these requirements, the following means are used: geostationary communication satellites; groups of low-orbital satellites; a branchy network of retranslation stations covering the territory, which stations are represented by high-rise constructions.

The aforementioned means, however, bear a number of essential shortcomings. First of all, this is excessively high costs for placing the satellites on the orbit and maintaining them thereon. For example, the cost might reach about 500 million US dollars. Further, the low-orbit satellites move with a high speed in relation to land-located communication stations that creates a lot of problems for quality of transmission and retranslation of the communication signal along the “land station-satellite” communication line. The creation of a vast network of retranslation antennas is a long and expensive solution, since it relates to building and maintaining high-rise constructions, instability of such constructions and antenna-communication equipment mounted therein in unfavorable weather and seismic conditions, vulnerability the constructions under wind loads, and malicious actions of different character.

Russian Federation Patent Nr. 2176852 describes a communication system comprising land stations, executed as multi-channel and user radio terminals, aircraft for placement of transmission-receiver equipment intended for two-way communication between the aircraft and land stations; the equipment comprises a multi-channel reception device connected, via a signal decoding and formation unit, with a multi-channel transmission device, differing in that the aircraft is linked to the land by means of a cable with electric wiring for powering the equipment and signal wires for two-way communication within the equipment, and between the equipment and the corresponding land station.

Another closely related art invention is described in a Russian Federation Patent Nr. 2180767, which invention relates to the technology of communication and transmission of information. Its aerodynamic integral telecommunication system comprises at least one land-linked aerodynamic aircraft bearing reception-transmission equipment; and at least two land stations. In this regard, the aircraft are joined in groups for regional services; at least one aircraft, servicing one region, is supplied with transmission-reception equipment for communication with at least one aircraft servicing another region, and/or with a communication satellite. The land-linked aerodynamic aircraft includes at least two carrying surfaces mounted on an element coupled with a fuselage, having in its front part aerodynamic guidance blades, stabilizer blades joined with the carrying surfaces forming a casing, and cable systems for coupling the element and the carrying surfaces to the fuselage. The aerodynamic integral telecommunication system also includes a power unit that can be made as a windmill. Such system is characterized with a lower cost and a higher level of maintenance-ability and environment safety.

The above-described inventions, however, have a number of significant drawbacks. First, the cable and wires, connected to land constructions, do not allow placing the aircraft high enough, which is necessary to cover big territories, and result in the aircraft and the equipment mounted thereon being dependent upon disorders on the land station and unstable as to impacts on the cable and wires, and on the aircraft itself through the cable (e.g. a higher power voltage, or electro-magnetic impulse).

### AIMS AND BRIEF DESCRIPTION OF THE PRESENT INVENTION

The primary purpose of this invention is to solve a problem of creation of an autonomous lighter-than-air aircraft, and to propose a method for providing radio and optical communication, television broadcasting, and monitoring that will be free from the indicated drawbacks, which aircraft will be inexpensive, autonomous in relation to the land resources, practically immovable relatively to the land telecommunication and television reception stations (herein also called ‘signal recipients’), and environment friendly.

These problems have been solved and the solution is implemented in the instant invention that contemplates an autonomous stratospheric aircraft being lighter than air, and to a method for providing radio and optical communication, television broadcasting, and monitoring. According to the method, the autonomous stratospheric aircraft being lighter than air is employed for providing radio and optical communication, television broadcasting, and monitoring, which is different in that the aircraft is supplied with:—a solar panel intended for saving energy used, during the day time, by units of the aircraft, including, without limitation, engines of the aircraft, and equipment necessary for optical communication, television broadcasting, and monitoring; fuel cells and/or electric accumulative batteries used, during the night time, for power supply of the units of the aircraft; the aircraft utilizes the aforesaid engines for spatial stabilization; the aircraft is not connected by cables or any other mechanical means with the earth surface, and, with the help of its own engines, is stationary placed in a low atmosphere layer of at least 18 kilometers over the earth surface.

For carrying out the aforesaid method, the equipment is disposed onboard of the aircraft, and power supply is provided at the expense of own resources of the aircraft.

The use of the inventive autonomous stratospheric aircraft being lighter than air, and the method for providing radio and optical communication, television broadcasting, and monitoring result in achieving the following advantages:

costs of the building and maintaining of the autonomous stratospheric aircraft being lighter than air are essentially lower than the ones for an artificial satellite;

the autonomous stratospheric aircraft being lighter than air is capable of returning to the earth surface for technical services and repair;

a vast territory can be served with radio and optical communication, television broadcasting, and monitoring due to the greater height of placement of the aircraft; and

the autonomous stratospheric aircraft being lighter than air is capable of practically immovable positioning in relation to the land communication stations, due to the regularity of stratospheric winds and having its own power supply.

In an embodiment of the present invention, the retranslation and transmitting equipment is placed on the autonomous stratospheric aircraft being lighter than air, wherein the aircraft is positioned in a low stratospheric layer of 20 km, a radius P of the covered communication zone can be calculated by formula:

P=(2hR+h²)^{0.5},

wherein h is the height of aircraft positioning; R is a radius of the Earth.

If h=20 km, R will approximately be equal to 500 km that may allow using one such aircraft for arrangement of communication and television for a scaled region of a country.

The stability of such aircraft is supported by its own resources, for which reason it's possible to use turbo jet engines with a variable thrust vector for horizontal and vertical stabilization of the aircraft's platform in relation to stratospheric winds.

It's considered expedient to determine a necessary stationary position of the proposed aircraft by using astronavigation systems, since, in the low atmosphere layers, stars can be stably viewed at any daytime.

It's also considered technically expedient to determine a necessary stationary position of the proposed aircraft by using natural and artificial landmarks on the earth surface, since a short distance from the aircraft to these landmarks increases a relative accuracy of positioning the proposed aircraft.

It's considered technically expedient to determine a necessary stationary position of the proposed aircraft by using position signals received from artificial satellites of the Earth. In this case, it will allow using proven technologies of global navigation.

It is recommended to use optical and/or electro-communication channels for control of the aircraft, as well as to envisage a possibility of landing, or coupling to special construction located on the earth surface, or coupling to similar aircraft for maintenance and modernization.

Besides, a basic design feature of the proposed aircraft should be the principle of minimal maintenance and maximal repair-ability. In connection therewith, the following types of electric power supply should preferably be employed: fuel cells, accumulative batteries, super-capacitors, other technically suitable generators and accumulators of electric energy.

Considering environment and fire safety, it's reasonable to use a double-chamber shell having an inner chamber filled with hydrogen, and an outer chamber filled with helium. It is preferable to use a spherical or disc shape for designing the aircraft. This design provides for efficient cargo-capacity in comparison to the aircraft with only one shell filled with helium. On the other hand, such design does not reduce fire safety, since the inner chamber filled with hydrogen has no contact with the environment.

With the intention of increasing accuracy of the location of signal recipients, reducing the power of transmitted signal, and/or directional communication of information, it is deemed preferable to include into the signal any relevant information for determination of the location of the signal recipients. This relevant information can be exemplarily represented by relative time expressed in units of a stable frequency, which would allow, based on a signal delay, determining the distance. The increase of accuracy would be provided at the expense of a close distance to the recipients due to a reduction of the relative operational margin. For comparison: the distance for geostationary satellites of global navigation can be estimated as 32,000 km, whereas, for the proposed aircraft, it's estimated as roughly 500 km, which would raise the accuracy of determining the location in 50 times.

The present invention will be disclosed in detail herein below, based on an exemplary preferred embodiment of the invention, referring to FIGURE schematically showing a flowchart of the inventive system.

### DESCRIPTION AND OPERATION OF PREFERRED EMBODIMENTS OF THE INVENTION

The inventive system is structured and operates as follows. Block 7 is a land communication station irradiates a communication (radio) signal, which is received by block 2 being a receiver of radio signals from land stations. Block 3 is a device for amplifying, processing, and retranslation of the signal. Block 3 receives the signal from block 2, processes the signal according to a protocol and a communication type used in the system, and then passes the processed signal to block 4 being a transmitter of radio signals. Block 4 irradiates the signal that is further received by block 8, being another land communication station.

Block 5 is a power supply unit that supplies electric energy for the reception, processing, re-translation, and transmission equipment (blocks 2-4). For electrical power supply of the equipment of the proposed aircraft, block 5 employs solar panels during the daytime, fuel cells and/or accumulative electric batteries during the nighttime.

Block 6 provides control and stabilization of the aircraft, for which purpose block 6 employs own engines of the aircraft for spatial stabilization when a location point of the aircraft is assigned with the help of astronavigation equipment.

Thusly, blocks 1-6 are stationary positioned in the low atmosphere layer, essentially 18-20 kilometers above the earth surface, due to the action of the aircraft own engines, without cables or another mechanical linkage with the earth surface.

Comparatively to the related art lighter-than-air aircraft known to the authors of the present invention, and to the known methods for providing radio and optical communication, television broadcasting and monitoring, the present invention, utilizing the equipment placed on the aircraft, provides for: low costs of montage and maintenance, autonomous operation, coverage a vast territory, and practical immobility in relation to the land stations.

The major advantages of the inventive autonomous stratospheric aircraft being lighter than air, and of the inventive method for providing radio and optical communication, television broadcasting and monitoring by means of the onboard equipment disposed on the aircraft follow.

costs are reduced hundreds times in comparison with a group of communication satellites;

replaceability and repairability, long service span, capability of modification of communication and other technological devices;

practically full connection and high stability of the inventive communication system (due to viewing from a location point of one aircraft of several other aircraft points);

capability of inter-regional communication via one or several retranslation aircraft units;

capability of disposition of means for optical surveillance and monitoring of emergency situations;

capability of deployment of the inventive system for communication in emergency situations;

capability of operatively providing high-speed communication channels for any consumers without capital expenses for placement optical cables of ‘last mile’, which is essential in the conditions of Russian territory;

providing a higher level of reliability and stability in the conditions of industrial disaster comparing with regular telecommunication infrastructures;

practical inapproachability for mobile anti-aircraft weapons.

For the purposes of the present invention, the term of ‘monitoring’ means any monitoring presently executed by means of stationary (mounted on a rig, mast, platform) equipment, or mobile (mounted on a maimed or unmanned aircraft, land-based or water-based platform) tracking equipment. Respectively, the type of equipment based on the claimed stratospheric aircraft determines the scope of environment surrounding the object being monitored. Exemplarily, the monitoring can be provided for objects located on the earth (land and water) surface, in the surface-proximate layers of lithosphere and hydrosphere, as well as in the atmosphere and cosmos space.

In particular, the systems for monitoring territories and water zones, being placed on the inventive aircraft, would allow solving a number of acute complex problems of safety of people and countries, and economic activities.

One of preferred embodiments of the inventive monitoring system would provide continuous surveillance of any transportation means with the purposes of enhancement logistics thereof, prevention of theft, illegal possession, or use thereof, and prevention of hiding the illegally possessed transportation means.

Such monitoring would be especially effective for transportation means supplied with identification devices, easy locatable in a frequency range preset in the tracking equipment, though the installation of such identification devices is not mandatory for the inventive system. Such frequency range can be represented by a diapason (section) of infrared or visible light, radio waves, etc. The preferable frequency range would be the one wherein the signal could be registered with a high probability in different tropospheric conditions. For example, if the monitored object is covered by a cloud, it would not prevent the registration of signal in predetermined infrared or RF diapasons. An object having a temperature higher than the surroundings can be identified in a predetermined infrared diapason.

An advantageous approach can be proposed that consists in furnishing transportation means with infrared or visible markers (e.g. two-dimensional) containing coded data about the transportation means.

In another preferred embodiment of the inventive monitoring system, closely associated with the previous one, the claimed aircraft can be participated in a road safety system. For instance, it can provide monitoring the drivers of motor vehicles taking part in the monitored traffic with the purpose of compliance thereof to the traffic rules and regulations, e.g. speed limits, lane observations, etc., as well as other road situations, such as traffic congestions, accidents, and so on. This could be made even more efficient, if the road would be covered with special markers easily read in a predetermined frequency diapason set on the tracking equipment mounted on the inventive stratospheric aircraft.

In another preferred embodiment of the inventive monitoring system, beneficial for Russia and other countries that possess significant forest resources, a real time multi-aspect monitoring can be provided for:—maintaining a decrease of quantities of the forest resources,—an identification of places of illegal coupe and outflow of illegally cut trees,—continuous monitoring of the fire safety situation,—detection of illegal trespassing in sanctuary areas and national parks, etc.

It's worth noting that the modern level of development of optical technology allows for not only registering the location of a monitored object (e.g. a transportation vehicle, a human, etc.), but also for surely identifying thereof.

In yet another preferred embodiment of the inventive monitoring system, a monitoring can be provided for natural disasters and emergency situations, including long time situations, such as floods, etc.

A person skilled in the art may apparently discover many variations and ramifications of the technical solutions disclosed herein. Therefore, the present invention is not limited by the particular examples described hereinabove, but also embraces such variations and ramifications.

1. An autonomous stratospheric aircraft being lighter than air for providing radio and optical communication, television broadcasting and monitoring; said aircraft comprises:
engines;
communication equipment used for radio and optical communication, television broadcasting and monitoring, said communication equipment is mounted onboard of the aircraft;
a solar panel supplying power for the engines and the communication equipment of said aircraft during the daytime; and
fuel cells and/or electric accumulative batteries, supplying power for the engines and the communication equipment during the nighttime;
wherein: said aircraft employs said engines for spatial stabilization; said aircraft is not bound to the earth surface by any mechanical means; and said aircraft is stationary disposed in a predetermined low layer of the earth atmosphere.

2. The autonomous stratospheric aircraft according to claim 1, wherein said aircraft is stationary disposed at least 18 kilometers above the earth surface.

3. The autonomous stratospheric aircraft according to claim 1, wherein said aircraft employs an astronavigation system arranged thereon for determination of a stationary position of said aircraft.

4. The autonomous stratospheric aircraft according to claim 1, wherein natural and artificial landmarks on the earth surface are used for determination of a stationary position of said aircraft.

5. The autonomous stratospheric aircraft according to claim 1, wherein positioning signals received from artificial satellites are used for determination of a stationary position of said aircraft.

6. The autonomous stratospheric aircraft according to claim 1, wherein optical and/or electrical communication channels are used for control thereof; said aircraft is capable of landing on the earth surface, or of coupling to special constructions located on the earth surface, or coupling to other analogous aircraft for maintenance and modernization.

7. The autonomous stratospheric aircraft according to claim 1, wherein said aircraft has a double-chamber shell consisting of an outer chamber filled with helium and an inner chamber filled with hydrogen.

8. A method for providing radio and optical communication, television broadcasting and monitoring by means of the aircraft according to claim 1, said method comprising the steps of:
stationary placing said aircraft in a predetermined low layer of the earth atmosphere;
using said engines for spatial orientation of said aircraft;
supplying electric power to said engines and said communication equipment from said solar panel during the daytime;
supplying electric power to said engines and said communication equipment from said fuel cells and/or said electric accumulative batteries during the nighttime;
thereby enabling said communication equipment for providing the radio and optical communication, television broadcasting and monitoring.

9. The method according to claim 8, wherein, for providing the radio and optical communication, television broadcasting and monitoring, said communication equipment transmits signals, and, the transmitted signals include information for determining the location of recipients receiving said transmitted signals.

10. The use of the aircraft according to claim 1 for surveillance of transportation means for the purposes of: arrangement of logistics thereof; prevention of theft, or illegal possession, or illegal use thereof; prevention of hiding the transportation means in case of illegal possession thereof.

11. The use of the aircraft according to claim 1 for monitoring the observation of road rules and regulations by drivers of motor vehicles, and for monitoring traffic congestions and accidents.

12. The use of the aircraft according to claim 10, wherein said aircraft is furnished with tracking equipment mounted on the aircraft, said tracking equipment has a predetermined frequency diapason, and said transportation means are furnished with markers easily read in said predetermined frequency diapason by said tracking equipment.

13. The use of the aircraft according to claim 1 for monitoring forest resources, including: monitoring a decrease of quantities of the forest resources in a real time mode with an identification of places of illegal coupe and outflow of illegally cut trees, monitoring of fire safety conditions, detection of illegal trespassing in sanctuary areas and national parks.

14. The use of the aircraft according to claim 1 for monitoring natural disasters and emergency situations, including floods.

15. The use of the aircraft according to claim 11, wherein said aircraft is furnished with tracking equipment mounted on the aircraft, said tracking equipment has a predetermined frequency diapason, and said motor vehicles are furnished with markers easily read in said predetermined frequency diapason by said tracking equipment.
